(19) United States
(12) Patent Application Publication
(10) Pub. No.: US 2024/0217078 A1
(43) Pub. Date: Jul. 4, 2024

(54) COMPRESSION TOOL COUPLABLE TO A BATTERY-POWERED IMPACT WRENCH

(71) Applicant: RESTART INDUSTRIA, COMERCIO, IMPORTACAO, EXPORTACAO DE EQUIPAMENTOS E ACESSORIOS ELETRICOS LTDA., Porto Alegre (BR)

(72) Inventor: André Luis Muller Da SILVA, Porto Alegre/RS (BR)

(21) Appl. No.: 18/562,991

(22) PCT Filed: May 30, 2022
(86) PCT No.: PCT/BR2022/050182

§ 371 Date: Nov. 21, 2023

(30) Foreign Application Priority Data
May 31, 2021 (BR) 202021010552-1
Nov. 8, 2021 (BR) 202021022416-4
Dec. 21, 2021 (BR) 202021025911-1

(51) Int. Cl. B25B 27/02; H01R 43/26

(52) U.S. Cl. CPC B25B 27/023; H01R 43/26

(57) ABSTRACT

The present patent relates to a compression tool (1) comprising a lead screw (2); a support tip (4); a rear engagement (5), such as an engagement tip in a battery-powered impact wrench (B); and an applicator body (A) comprising a rear block (6A) arranged perpendicularly to and symmetrically centered on the rear end of said applicator body (A) and having a threaded hole (7) for passage/fastening of the lead screw (2), and a front block (6B) arranged perpendicularly to and symmetrically centered on the front end of said applicator body (A); wherein the lead screw (2) is fitted into the applicator body (A) by screwing through the threaded hole (7) of the rear block (6A) of said applicator body (A).

The present invention belongs to the technical field of applicator tools in general, more specifically it describes a compression tool couplable to a battery-powered impact wrench which, according to its general characteristics, has as its basic principle to provide the formation of a compression tool in its own and specific structure of the universal type, including improvements introduced both in the applicator body through adjustments in the threaded hole, as well as in the lead screw with a support tip and compression dies, for fitting/fastening of connectors, terminals and splices, in order to allow, in an extremely practical, safe and precise way, a complete optimization in the set of procedures for applying compression to connectors (e.g., wedge-type), terminals and splices, when joining conductors of electrical power distribution networks by using battery-powered impact wrenches, combined with the absence of wear and tear on conductors, connectors, terminals and splices and improvements in the maintenance of electrical power distribution networks.

With a specific and easily accessible design and format for better adaptation and user safety, practical handling and functionality, very affordable and, due to its general characteristics and dimensions, easily adaptable to a wide range of battery-powered impact wrenches, power conductors, locations, and technicians in general, regardless of the characteristics they may present.

Currently, one of the main problems in the maintenance of electrical power distribution networks is the electrical connections between electric power cables/conductors, which are usually made, for example, by means of wedge-type connectors—equipment used in low and medium-voltage network branches.

Nowadays, some models of tools for installing and applying wedge-type connectors that use color-coded polymeric or metal cartridges according to the connector model, in addition to other models that use a hydraulic tool and a screwdriver, exclusively for the models of the connector brand itself, are widely known in the state of the art.

In an extensive review of the literature in order to provide the current state of the art of tools used in the application of compression to connectors, terminals and splices on electric power conductors, object of the present patent of invention, documents relevant to the prior art disclosing this type of tool were described, but none of them presents the same structural and operational concept as claimed by the present compression tool couplable to a battery-powered impact wrench.

These tools include: robotic tools powered by electric batteries, such as battery-powered compression pliers; terminal press tools adapted to truck hydraulic systems or portable hydraulic pumps; AMPACT tools, which consist of a piston that applies the connector by exploding a specific charge for each type of connector, polymeric or metal cartridges by color according to the connector model—Tyco Electronics model; ECONET tools, which apply the connector through a screwing system using an electric screwdriver with a specific application limitation for your tool; and WORK tools, which apply a system similar to that of ECONET, but the connector is applied manually using a ratchet wrench due to ergometric limitations and laborious application.

However, although these tools are widely known and used by the most varied technicians, they have the disadvantage of not being universally applicable to all the models of heads and connectors that they cover, resulting in high tool and maintenance costs, as well as having a complex and risky operation, especially since most of them use explosive cartridges to apply wedge connectors.

In this line of action, it has become essential for power utility companies to structure a versatile, safe and precise tool capable of allowing the optimization of the procedures for applying compression to connectors (e.g., wedge-type connectors), terminals or splices, on power conductors in electrical networks, in order to increase the safety of technicians, reduce maintenance costs and increase the strength and durability of conductor connections, in addition to being universally applicable.

The present invention is characterized by combining components in a differentiated design that meets the various requirements the nature of its use demands, that is, the application of compression to connectors, terminals or splices, by using impact wrenches. The concept ensures an application tool of great efficiency, functionality, strength, durability, safety, versatility, hygiene and ergonomics, thanks to the excellent added technical qualities that provide advantages and improvements in the procedures for applying compression to connectors, terminals or splices on power conductors of electrical power distribution networks in general, and whose general characteristics differ from the other shapes and models widely known in the current state of the art.

The present patent of invention comprises the use of a modern, efficient, safe, and functional compression tool couplable to a battery-powered impact wrench formed by a set of properly incorporated mechanical and electrical solutions, forming a complete and differentiated application tool in a single, complete and safe assembly, whose shapes and internal and external arrangements allow a seamless adaptation to several different types of connectors, terminals, splices and battery-powered impact wrenches, being specially designed for these purposes.

More specifically, the general design of the present compression tool couplable to a battery-powered impact wrench is based entirely on its simple and robust structure, with a minimum of components required and extremely simplified, safe and optimized applicability, combined with very practical manufacturing procedures, in order to obtain a practical and efficient compression tool of the universal type capable of being coupled to a battery-powered impact wrench, so that the connectors, terminals or splices can be applied/removed, and can be used, for example, in wedge-type connectors and applicator bodies, such as large or small heads already known in the state of the art—use of the universal type, in addition to terminals or splices, including, for example, the heads of existing AMPACT tools, but without the need to use explosive cartridges and without tool firing noises.

Given this and other points, we have developed a compression tool in the shape of a tip, which is subsequently coupled to an impact wrench responsible for its activation and incorporated by passing/threading a lead screw in an applicator body, which is responsible for supporting it and helping it to apply the connector, terminal or splice.

It should be noted that the compression tool dispenses the use of explosive cartridges and complex tools, performing tasks with the same efficiency as other devices and generating great savings in parts and costs by eliminating the need to purchase and dispose of cartridges for the application.

The present compression tool is based on the application of components and processes in a differentiated design without, however, reaching a high degree of sophistication and complexity, thus making it possible to solve some of the main drawbacks of other shapes and models known in the state of the art and used for the application of connectors, terminals or splices by using impact wrenches, which are located in an operating range in which are very common the limitations in use and application, low efficiency and performance, frequent accidents of varying severity, low durability and strength, low versatility, high cost, general high volume and weight, low ergonomic capacity, low flexibility and mobility, and low strength and load-bearing capacity.

The objectives, advantages, and other important characteristics of the patent of invention in question can be more easily understood when read in conjunction with the accompanying drawings, in which:

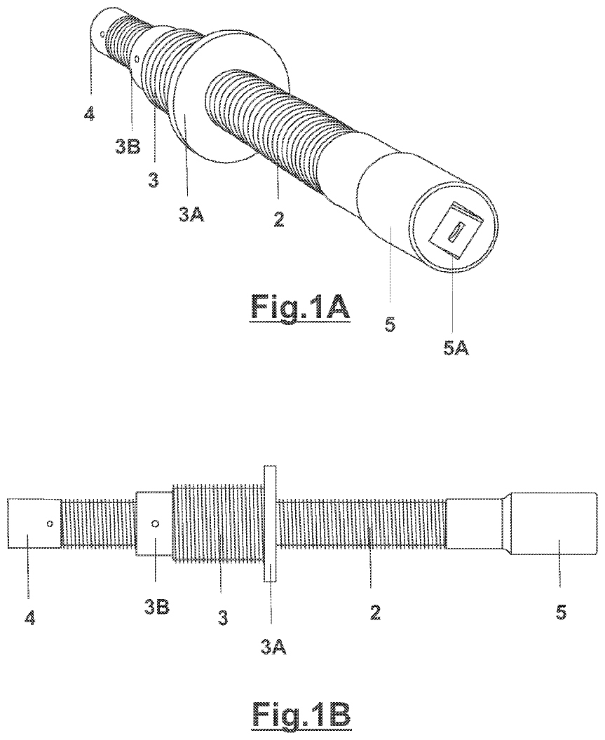

FIG. 1 is a perspective view of the lead screw of a compression tool couplable to a battery-powered impact wrench in a first alternative embodiment of the present invention.

FIG. 1B is a top view of the lead screw of the compression tool couplable to a battery-powered impact wrench in a first alternative embodiment of the present invention.

FIG. 1C is a cross-section side view of the lead screw of the compression tool couplable to a battery-powered impact wrench in a first alternative embodiment of the present invention.

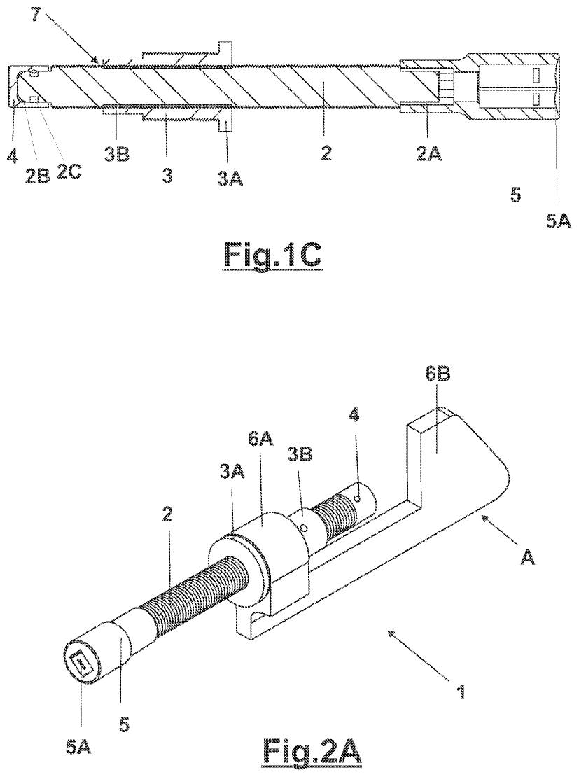

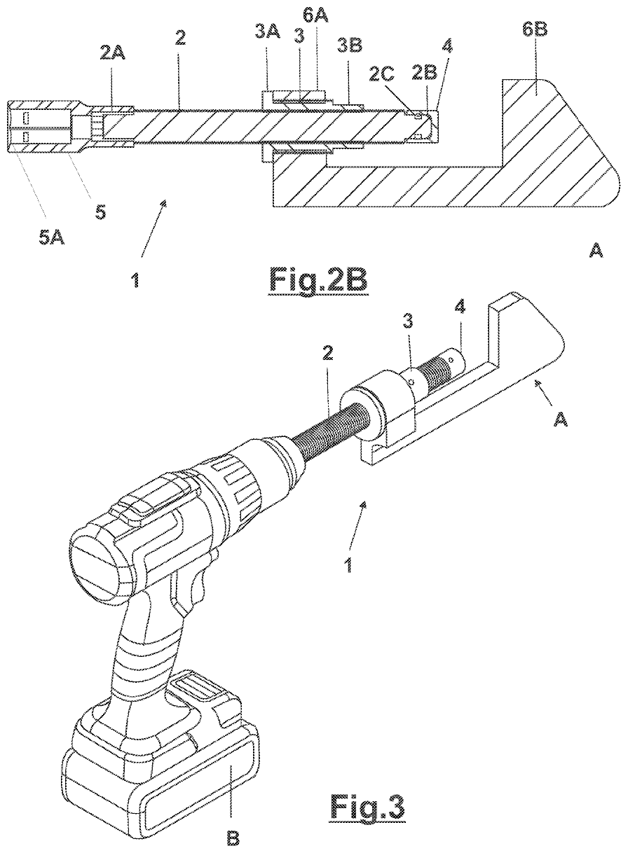

FIG. 2A is a perspective view of the compression tool couplable to a battery-powered impact wrench with the lead screw fixed in an applicator body in a first alternative embodiment of the present invention.

FIG. 2B is a cross-section side view of the compression tool couplable to a battery-powered impact wrench with the lead screw fixed in an applicator body in a first alternative embodiment of the present invention.

FIG. 3 is a perspective view of the compression tool couplable to a battery-powered impact wrench in a first alternative embodiment of the present invention.

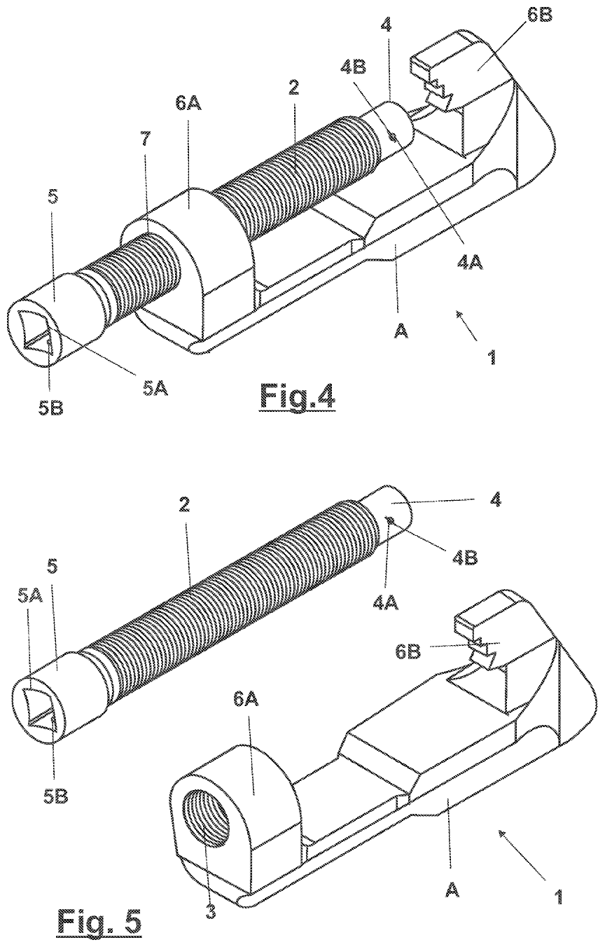

FIG. 4 is a perspective view of the compression tool couplable to a battery-powered impact wrench in a second alternative embodiment of the present invention.

FIG. 5 is an exploded perspective view of the compression tool couplable to a battery-powered impact wrench in a second alternative embodiment of the present invention.

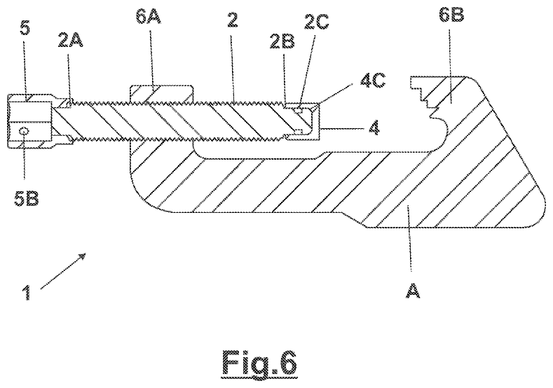

FIG. 6 is a longitudinal cross-section side view of the compression tool couplable to a battery-powered impact wrench in a second alternative embodiment of the present invention.

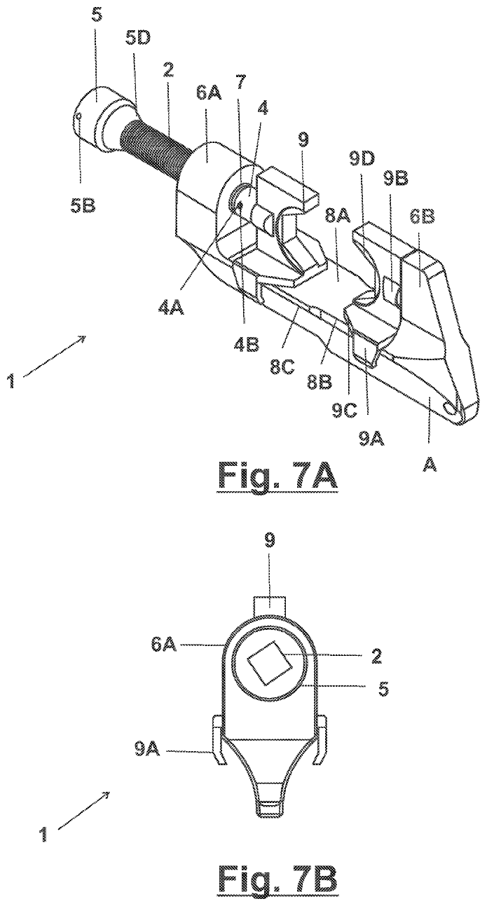

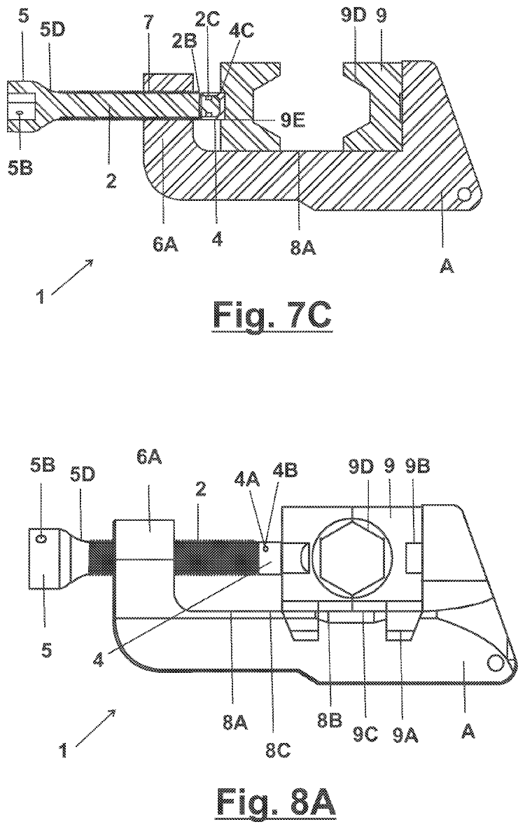

FIG. 7A is a perspective view of the compression tool couplable to a battery-powered impact wrench in a third alternative embodiment of the present invention.

FIG. 7B is a rear view of the compression tool couplable to a battery-powered impact wrench in a third alternative embodiment of the present invention.

FIG. 7C is a cross-section side view of the compression tool couplable to a battery-powered impact wrench in a third alternative embodiment of the present invention.

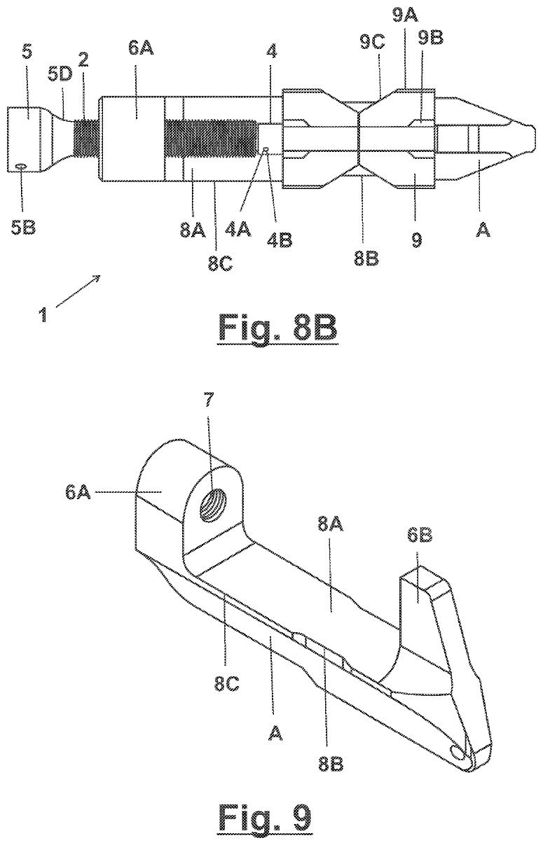

FIG. 8A is a side view of the compression tool couplable to a battery-powered impact wrench in the closed position in a third alternative embodiment of the present invention.

FIG. 8B is a top view of the compression tool couplable to a battery-powered impact wrench in the closed position in a third alternative embodiment of the present invention.

FIG. 9 is a perspective view of the applicator body of the compression tool couplable to a battery-powered impact wrench in a third alternative embodiment of the present invention.

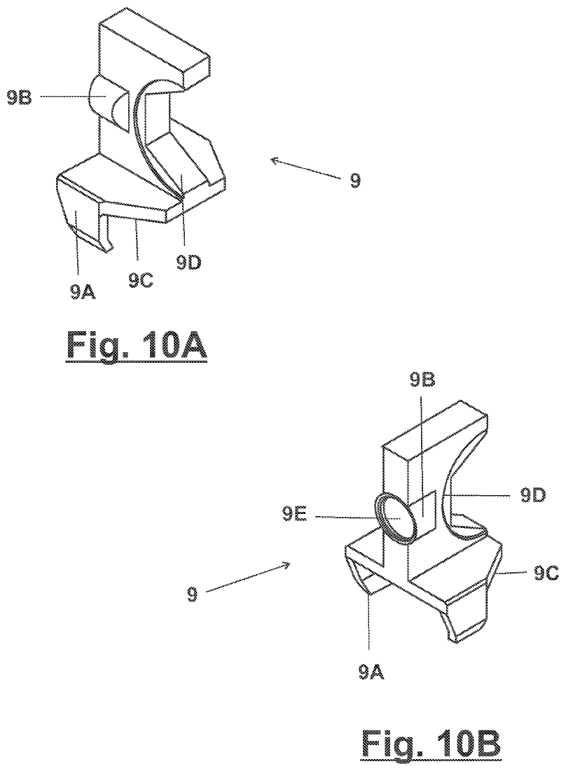

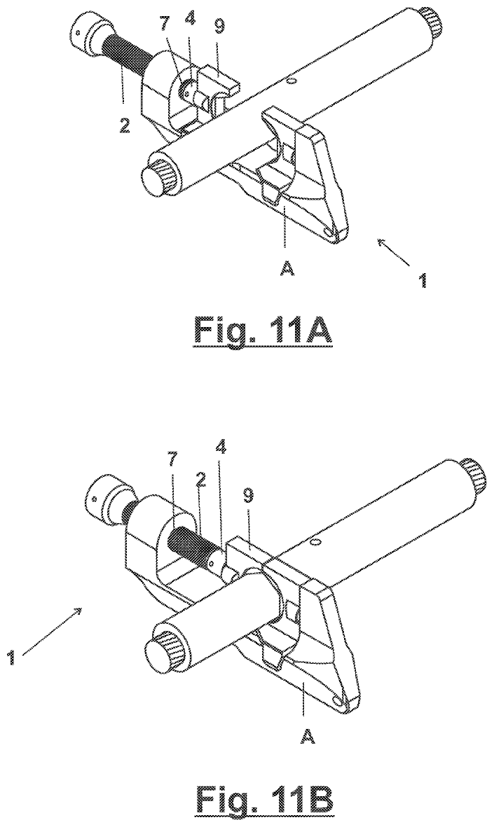

FIG. 10A is an internal perspective view of the compression die of the compression tool couplable to a battery-powered impact wrench in a third alternative embodiment of the present invention.

FIG. 10B is an external perspective view of the compression die of the compression tool couplable to a battery-powered impact wrench in a third alternative embodiment of the present invention.

FIG. 11A is a perspective view of the application of the compression tool couplable to a battery-powered impact wrench in the compression position—a splice before being compressed—in a third alternative embodiment of the present invention.

FIG. 11B is a perspective view of the application of the compression tool couplable to a battery-powered impact wrench in the compressing position in a third alternative embodiment of the present invention.

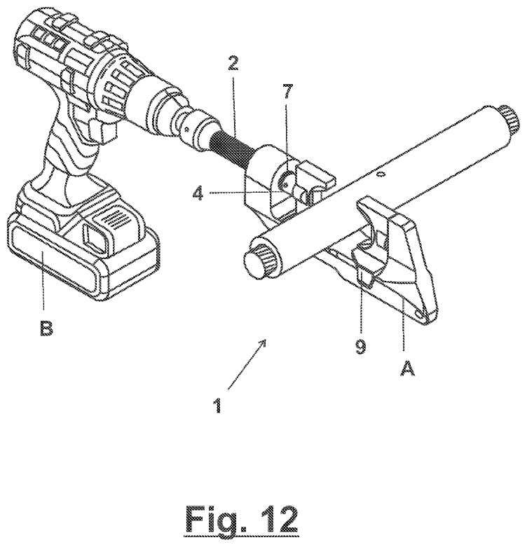

FIG. 12 is a perspective view of the compression tool couplable to a battery-powered impact wrench in a third alternative embodiment of the present invention.

As shown from the accompanying drawings that illustrate and integrate the present descriptive report of the patent of invention “Compression Tool Couplable to a Battery-Powered Impact wrench”, FIGS. 1A to 3 shows the compression tool in general in a first embodiment of the present invention, comprising a compression tool (1) complete and with specific characteristics, incorporating its own structure of universal type, of high durability and strength, cylindrical shape, with internal and external shapes and arrangements that adapt to a wide range of connectors, terminals or splices, applicator bodies (A), such as heads, and battery-powered impact wrenches (B), and containing properly integrated and symmetrically arranged between them a cylindrical lead screw (2) with an external thread, symmetrically arranged along the entire length of the compression tool (1) and having a rear recess (2A) of cylindrical shape and symmetrically arranged around the rear end of the lead screw (2), a front recess (2B) of cylindrical shape and symmetrically arranged around the front end of the lead screw (2), and two holes (2C) symmetrically aligned on the upper and lower faces of the rear recess (2B), the whole set with the main function of structuring the compression tool (1); alternatively, a cylindrical bushing (3), with an internal thread and cross-section similar to a “lying T”, arranged parallel and symmetrically threaded in the lead screw (2) and having a rear flange (3A) of annular shape and arranged perpendicularly to and symmetrically centered on the rear end of the bushing (3), and a front recess (3B) of cylindrical shape and symmetrically arranged around the rear end of the bushing (3), the whole set with the main function of fitting/fixing the lead screw (2) in the applicator body (A); a support tip (4), such as an impact tip, of cylindrical shape and symmetrically fitted into the rear recess (2B) of the lead screw (2), the whole set with the main function of contacting the compression tool (1) to a wedge-type connector, terminal or splice, inside the applicator body (A); and a rear engagement (5), such as an engagement tip, of cylindrical shape, symmetrically fitted into the rear recess (2A) of the lead screw (2) fitted to the battery-powered impact wrench (B) and having a hole (5A) with a square section of the built-in sock coupling type and centered along the inner portion of the rear engagement (5), the whole set having the main function of fixing the compression tool (1) on the battery-powered impact wrench (B).

The compression tool (1) further comprises a semicircular rear block (6A) arranged perpendicularly to and symmetrically centered on the rear end of the applicator body (A) with a cylindrical threaded hole (7) horizontally and symmetrically centered and passing through said rear block (6A) of the upper-rear part of the applicator body (A) for crossing/fixing a lead screw (2); and a front block (6B) arranged perpendicularly to and symmetrically centered on the front end of said applicator body (A).

The operation of the compression tool couplable to a battery-powered impact wrench is based on its correct handling with the applicator body (A) and the battery-powered impact wrench (B). The lead screw (2) is fitted in the applicator body (A) by passing through the rear portion of the opening of the rear block (6) of the applicator body (A), for instance, so that the bushing (3) remains partly inside this rear opening, in which case the lead screw (2) is locked in the applicator body (A) by the parallel contact of the rear flange (3A) on the rear face of the applicator body (A).

As shown from the accompanying drawings that illustrate and integrate the present descriptive report of the patent of invention “Compression Tool Couplable to a Battery-Powered Impact wrench”, FIGS. 4 to 6 shows the compression tool in general in a second alternative embodiment of the present invention comprising a compression tool (1) complete and with specific characteristics, incorporating a structure of universal type coupled to a battery-powered impact wrench and containing properly integrated and symmetrically arranged between them an applicator body (A) similar to a “U”, horizontally and symmetrically arranged along the entire lower length of the compression tool (1) and comprising a semicircular rear block (6A) arranged perpendicularly to and symmetrically centered on the rear end of the applicator body (A), and a front block (6B) containing internal steps and arranged perpendicularly to and symmetrically centered on the front end of the applicator body (A) for fitting/locking a connector according to its size; a threaded hole (7) of cylindrical shape and horizontally and symmetrically centered and passing through the rear block (6A) of the upper-rear part of the applicator body (A) for passing through/fitting a lead screw (2); a lead screw (2) of cylindrical shape horizontally and symmetrically arranged along the upper part of the applicator body (A) and screwed into the threaded hole (7) and comprising a rear recess (2A) of cylindrical shape and symmetrically arranged around the rear end of the lead screw (2), a front recess (2B) of cylindrical shape and symmetrically arranged around the front end of the lead screw (2), and two holes (2C) symmetrically arranged opposite and aligned on the upper and lower faces of the front recess (2B), a rear engagement (5) of cylindrical shape having a hole (5A) with a square inner hollow section of the built-in sock coupling type and symmetrically centered around the rear recess (2A) at the rear end of the lead screw (2) for coupling the battery-powered impact wrench, and a lock (5B) of cylindrical shape and arranged perpendicularly to and symmetrically inside the rear engagement (5) for coupling the driver of the battery-powered impact wrench; and a support tip (4) of cylindrical shape, symmetrically centered around the front recess (2B) at the front end of the lead screw (2) and comprising a hole (4A) arranged perpendicularly to and symmetrically on the side face of the support tip (4) for fitting a locking pin (4B), an inner cutout (4C) of cylindrical shape and symmetrically arranged at the inner end of the support tip (4), and the locking pin (4B) symmetrically passing through to the hole (4A) for locking the lead screw (2) in the applicator body (A).

The compression tool couplable to a battery-powered impact wrench, according to the application needs, can be provided with an impact wrench having a driving force generated by power from the mains or battery or even manually.

The operation of the compression tool couplable to a battery-powered impact wrench is based on the correct coupling by threading the lead screw (2) in the applicator body (A) and, subsequently, engaging the lead screw (2) into the battery-powered impact wrench.

The lead screw (2) is fitted directly into the threaded hole (7) by means of a thread between the parts, thereby generating the fitting of the lead screw (2) in the applicator body (A) and fixed in the battery-powered impact wrench by engaging the rear engagement (5) on the battery-powered impact wrench coupler, thereby generating the transmission of driving force from the battery-powered impact wrench.

In this second alternative embodiment of the present invention, the applicator body (A) is designed for use with commercial connectors on the market, wherein each step of the inner face of the rear block (6B) performs the locking of connectors of different sizes. In turn, the lead screw (2) is driven by the rear engagement (5) at the rear end of the lead screw (2), so that the lead screw (2) runs through its threaded portion inside the threaded hole (7). The lead screw (2) advances over the applicator body (A), and the support tip (4) is locked by the inner cutout (4C) upon contact. The lead screw (2) moves forward until the connector is properly installed in its respective position. During recoil, the support tip (4) is perfectly locked by the passage of the locking pin (4B) through the hole (4A).

As shown in the accompanying drawings that illustrate and integrate the present descriptive report of the patent of invention “Compression Tool Couplable to a Battery-Powered Impact wrench”, FIGS. 7A to 12 show the compression tool in general in a third alternative embodiment of the present invention comprising a compression tool (1) complete and with specific characteristics, incorporating a structure of universal type couplable to a battery-powered impact wrench, internal and external shapes and arrangements that adapt to a wide range of connectors, terminals and splices, and containing perfectly integrated and symmetrically among them:
A U-shaped applicator body (A), arranged vertically and symmetrically along the entire length of the compression tool (1) and comprising a semicircular rear block (6A) arranged perpendicularly to and symmetrically centered on the rear end of the applicator body (A), and a rectangular central base (8A) arranged parallel and symmetrically centered on the applicator body (A) and in the lower alignment of the rear block (6A) and having two side cutouts (8B) arranged parallel and symmetrically aligned at the lateral ends of the base (8A), and two side projections (8C) arranged parallel and symmetrically aligned along the entire length of the lateral ends of the base (8A);
a threaded hole (7) of cylindrical shape and horizontally and symmetrically centered and passing through the rear block (6A) of the upper-rear part of the applicator body (2) for crossing/fixing the lead screw (2);
a threaded lead screw (2) of cylindrical shape, horizontally and symmetrically arranged along the upper part of the applicator body (A) by means of its threading in the threaded hole (7), and comprising a concave curvature (5D) symmetrically arranged around the rear end of the lead screw (2) thread, a front recess (2B) of cylindrical shape and symmetrically arranged around the front end of the lead screw (2), two holes (2C) symmetrically opposite and aligned on the upper and lower faces of the front recess (2B), a rear engagement (5) of cylindrical shape having a hole (5A) with a square inner hollow section of the built-in sock coupling type and symmetrically centered around the rear end of the lead screw (2) for coupling the battery-powered impact wrench, and a lock (5B) of cylindrical shape and arranged perpendicularly to and symmetrically inside the rear engagement (5) for coupling the driver of the battery-powered impact wrench;
a support tip (4) of cylindrical shape symmetrically centered around the front recess (2B) at the front end of the lead screw (2) and having a hole (4A) arranged perpendicularly to and symmetrically on the side face of the support tip (4) for fitting a locking pin (4B), an inner cutout (4C) of cylindrical shape and symmetrically arranged at the inner end of the support tip (4), and the locking pin (4B) symmetrically passing through the hole (4A) for locking the lead screw (2) in the applicator body (A); and
two compression dies (9) similar to an inverted “T”, vertically, parallel and symmetrically aligned on the base (8A), fitted by the two side cutouts (8B) and locked by the two side projections (8C), each having two curved lower flanges (9A), arranged parallel and symmetrically spaced under the lateral ends of the base of the compression die (9) for fitting/sliding on the central base (8A)—locking flanges to prevent the compression die (9) from coming off, two semicircular lateral projections (9B), arranged parallel and symmetrically centered on the side faces of the upper rod of the compression die (9), two front chamfers (9C) symmetrically arranged at the anterolateral ends of the base of the compression die (9), a semicircular central recess (9D) with a semi-hexagonal internal section, vertically, parallel and symmetrically centered on the front face of the rod of the compression die (9)—surface for compressing the conductor cables, and a threaded hole (9E), arranged perpendicularly, horizontally and symmetrically centered on the rear face of the rod of the compression die (9) and in the alignment of the lead screw (2) with its support tip (4)—a slot for mounting the front end of the support tip (4); the compression dies (9) being wide to fit the most diverse types of terminals and splices of conductor cables.

The operation of the compression tool for the application of press terminals/splices couplable to a battery-powered impact wrench is based on the correct coupling by threading the lead screw (4) into the applicator body (2) and, subsequently, engaging the lead screw (4) with the battery-powered impact wrench.

The lead screw (2) is fitted directly into the threaded hole (7) by means of a thread between the parts, thereby generating the fitting of the lead screw (4) in the applicator body (A), and fixed to the battery-powered impact wrench by connecting the rear engagement (5) to the coupler of the battery-powered impact wrench, thereby generating the transmission of driving force from the battery-powered impact wrench.

In this third alternative embodiment of the present invention, the applicator body (A) is designed for the use of the two compression dies (9), so that the activation of the lead screw (2) is effected by the rear engagement (5) arranged at the rear end of the lead screw (2), allowing the lead screw (2) to run through its threaded portion inside the threaded hole (7). The lead screw (2) advances over the applicator body (A), and the support tip (4) is locked by the inner cutout (4C) upon contact. During recoil, the support tip (4) remains perfectly locked due to the passage of the locking pin (4B) through the hole (4A).

The compression dies (9) are supported and fitted symmetrically aligned and spaced on the base (8A), allowing them to slide perfectly on said base (8A) when driven by the lead screw (2), that is, making approximation (compression) or separation (relief) between them when acting directly on conductor cables that need terminals or splices.

The lead screw (2) moves until the first compression die (9) is properly installed in its respective rear position by penetrating the hole (9E) and pushing a first compression die (9) by sliding on the base (8A) toward a second compression die (9) and keeping the conductor cable between the two.

In standardized mechanical and electrical tests carried out in the laboratory and in the field, the compression tool couplable to a battery-powered impact wrench achieved excellent performance having reached one hundred percent efficiency, safety, and resistance, especially when compared to tools known for not requiring explosive cartridges for application of wedge-type connectors.

More specifically, the test results show that the compression tool couplable to a battery-powered impact drive presents the same results as other tools available on the market, having the advantage of not using traditional cartridges, thus generating significant cost savings by eliminating the need to purchase cartridges for use, contributing directly to the environment by not disposing of the cartridge after use, and allowing safer and more ergonomic use by eliminating the need to generate high mechanical impact.

As the compression tool couplable to a battery-powered impact wrench has fully integrated components, it can be assembled and disassembled quickly, nothing comes loose or breaks off, achieving a high performance and efficiency, combined with high durability and complete safety during use. Once fully integrated with each other and with the battery-powered impact wrench, the components are completely locked and united, thus preventing them from loosening during use, making the set fully available for the application procedures in wedge-type connectors, terminals or splices on conductors in electrical power distribution networks. The compression tool (1) can therefore be used without concerns of any nature, especially with regard to the safety and durability of its components and the safety of its users—the technicians of power companies.

In view of the foregoing, the present manual tool will be well received by power utility technicians who need to apply connectors, terminals or splices in general, since the compression tool couplable to a battery-powered impact wrench offers several advantages, such as: great safety, reliability and flexibility in its application; great efficiency and performance in its application due to its general design; high comfort, convenience and safety for power utility technicians; great overall strength and durability, combined with low no wear of the set as a whole; fully accessible cost, which provides an excellent cost-benefit ratio; practical and safe use by any electric power utility technician; long range; perfect and direct adaptation to the most varied types of wedge connectors and battery-powered impact wrenches; great mobility and flexibility of the set; high ergonomics and the certainty of having a compression tool (1) that fully meets the current rules and regulations required for its use.

All such attributes classify the compression tool couplable to a battery-powered impact wrench as a fully versatile, efficient, practical, and safe means for manual application procedures of a wide variety of connectors, terminals or splices, using several different types of battery-powered impact wrenches, by a large number of power utility technicians and in several different locations, regardless of the general characteristics these may have. It is to be understood, however, that the present invention is not limited to the specific embodiments described herein, but it is intended to encompass variations and modifications within the scope of protection thereof as defined by the attached claims.

1. “COMPRESSION TOOL COUPLABLE TO A BATTERY-POWERED IMPACT WRENCH”,
characterized in that it comprises a cylindrical lead screw (2) with an external thread, horizontally and symmetrically arranged along the upper part of the applicator body (A) of the compression tool (1), having a rear recess (2A) of cylindrical shape symmetrically arranged around the rear end of the lead screw (2), a front recess (2B) of cylindrical shape and symmetrically arranged around the front end of the lead screw (2), and two holes (2C) symmetrically aligned on the upper and lower faces of the front recess (2B); a support tip (4), such as an impact tip, of cylindrical shape and symmetrically fitted into the front recess (2B) of said lead screw (2);
a rear engagement (5), such as an engagement tip, of a cylindrical shape, symmetrically fitted into the rear recess (2A) of said lead screw (2), and a hole (5A) with a square section of the built-in sock coupling type and arranged centered along the inside of said rear engagement (5) for fitting a battery-powered impact wrench (B); and an applicator body (A) comprising a rear block (6A) arranged perpendicularly to and symmetrically centered on the rear end of said applicator body (A), with a cylindrical threaded hole (7) horizontally and symmetrically centered and passing through said rear block (6A) of the upper-rear part of said applicator body (A) for crossing/fixing the lead screw (2), and a front block (6B) arranged perpendicularly to and symmetrically centered on the front end of said applicator body (A); wherein the lead screw (2) is fitted into the applicator body (A) by screwing through the threaded hole (7) of the rear block (6A) of said applicator body (A).

2. “COMPRESSION TOOL COUPLABLE TO A BATTERY-POWERED IMPACT WRENCH”, according to claim 1, characterized in that it further comprises a cylindrical bushing (3), with an internal thread and arranged parallel and symmetrically threaded on the lead screw (2) and having a rear flange (3A) of annular shape and arranged perpendicularly to and symmetrically centered on the rear end of said bushing (3), and a front recess (3B) of cylindrical shape and symmetrically arranged around the front end of the bushing (3), in which the locking of the lead screw (2) on the applicator body (A) is effected by the parallel contact of the rear flange (3A) on the rear face of the applicator body (A).

3. “COMPRESSION TOOL COUPLABLE TO A BATTERY-POWERED IMPACT WRENCH”, according to claim 1, characterized in that the front block (6B) of said applicator body (A) comprises internal steps for fitting/locking.

4. “COMPRESSION TOOL COUPLABLE TO A BATTERY-POWERED IMPACT WRENCH”, according to claim 1, characterized in that it further comprises a cylindrical lock (5B) arranged perpendicularly to and symmetrically inside the rear engagement (5) for coupling the driver of the battery-powered impact wrench (B).

5. “COMPRESSION TOOL COUPLABLE TO A BATTERY-POWERED IMPACT WRENCH”, according to claim 1, characterized in that the cylindrical support tip (4), symmetrically centered around the front recess (2B) at the front end of the lead screw (2) comprises a hole (4A) arranged perpendicularly to and symmetrically on the side face of said support tip (4) for fitting a locking pin (4B); an inner cutout (4C) of cylindrical shape and symmetrically arranged at the inner end of the support tip (4); and the locking pin (4B) passing symmetrically through the hole (4A) to lock the lead screw (2) in the applicator body (A).

6. “COMPRESSION TOOL COUPLABLE TO A BATTERY-POWERED IMPACT WRENCH”, according to claim 1, characterized in that it further comprises:
a rectangular central base (8A), arranged parallel and symmetrically centered on the applicator body (A) having two side cutouts (8B) arranged parallel and symmetrically aligned at the lateral ends of the base (8A), and two side projections (8C) arranged parallel and symmetrically aligned along the entire length of the lateral ends of the base (8A); and
two compression dies (9) vertically, parallel and symmetrically aligned on the base (8A), fitted through the two side cutouts (8B) and locked by the two side projections (8C), each having two curved lower flanges (9A), arranged parallel and symmetrically spaced under the lateral ends of the base of the compression die (9) for fitting/sliding on the central base (8A), two semicircular lateral projections (9B), arranged parallel and symmetrically centered on the lateral faces of the upper rod of said compression die (9), two front chamfers (9C) symmetrically arranged at the anterolateral ends of the base of said compression die (9), a central recess (9D) with a semi-hexagonal internal section, vertically, parallel and symmetrically centered on the front face of the rod of said compression die (9), and a threaded hole (9E), horizontally, perpendicularly and symmetrically centered on the rear face of the rod of the compression die (9) and in the alignment of the lead screw (2) with its support tip (4).

7. “COMPRESSION TOOL COUPLABLE TO A BATTERY-POWERED IMPACT WRENCH”, according to claim 1, characterized in that said compression tool (1) can be actuated by an impact wrench (B) having a driving force generated by power from the mains or battery or even manually.
